(19) United States
(12) Patent Application Publication
(10) Pub. No.: US 2002/0102516 A1
(43) Pub. Date: Aug. 1, 2002

(54) Technique for installing dental implant assembly

(75) Inventors: Samer M. Srouji, Nazeret (IL); Hanna Ghrayab, Nazeret (IL)

Correspondence Address: OLIFF & BERRIDGE, PLC, P.O. BOX 19928, ALEXANDRIA, VA, 22320, US

(73) Assignee: Dentosonic, Ltd.

(21) Appl. No.: 09/774,591

(22) Filed: Feb. 1, 2001

(51) Int. Cl. A61C 8/00

(52) U.S. Cl. 433/173

(57) ABSTRACT

A technique for installing in the maxilla of a patient a dental implant assembly having a root section, a post section and a nut or locking element section. The root section is treaded to define a self-tapping screw which at its rear end is attachable to the post section and at its front end to the locking element section. To carry out this technique, the root section is screwed into a hole bored in the maxilla, the nose at the front end of this section then projecting into tie adjacent sinus cavity. The membrane lining the sinus cavity is lifted to admit the locking element section which is then attached to the nose to lock the root section to the maxilla. Then a charge of bone particles is deposited in the cavity to cover the nut section and the surrounding maxilla region. In a time period lasting several months, the bone particles gradually fuse with and graft onto the maxilla to augment its structure and embed the locking element section therein. Concurrently in the same period, the root section proceeds to fuse with the maxilla. This period of concurrent activity represents the total time it takes to complete the dental implant installation, after which it is feasible to mount a dental bridge on the post section.

### FIELD OF THE INVENTION

This invention relates generally to dental implants to replace missing teeth, and in particular to a method and an apparatus therefor for augmenting the maxilla of a patient suffering from bone loss and for installing a dental implant assembly therein in which the implant is anchored in bone grafted onto the maxilla.

### BACKGROUND OF THE INVENTION-STATUS OF PRIOR ART

A typical dental implant consists of a root section that is threaded to define a self-tapping screw to which is attached a post section to support a dental bridge.

Dental implants are surgically introduced into the mandible (lower jaw) or to, the maxilla (upper jaw) along the occlusal plane. It is effected by cutting through the gingival tissue to expose the bone into which a hole is then bored. The root section of the implant is then screwed into the bone hole to tap an internal thread therein. After the root section is screwed into the hole, the gingival tissue is sutured about the bone and the base of the post protruding from the hole.

It is not feasible just after installing a dental implant to then mount a dental bridge on the post to support artificial teeth. Before doing so it is necessary to wait for a time period lasting several months to permit the root section to gradually fuse and become integrated with the bone. Only then will the implant be securely anchored in the bone so that it cannot be dislodged by mastication or other forces imposed on the bridge.

The concern of the present invention is with dental implants to be installed in the maxilla of a patent. Because of bone loss the maxilla must be augmented by a graft which is to be developed within the patient's maxilla sinuses. These sinuses are located on either side of the nose, being positioned between the eye sockets above and the upper teeth below. With a an individual's maxillary sinuses grow larger at the expense of the maxilla. Moreover periodontal disease may cause reabsorption of the bone surrounding the sinuses. When a patient has experienced a substantial loss of bone, the feasibility of a maxillary dental implant is diminished with a resultant increase in the rate of failure.

Thus the bone in the maxillary dental arch of a patient having an enlarged maxillary sinus condition is usually incapable of effectively accommodating a dental implant. As pointed out in the 1996 U.S. Pat. No. 5,547,578 to Linkow, should one subject this patient to an implantation procedure, this may result in the penetration of the Schneiderain membrane on the floor of the sinus cavity and of the sinus itself. This invasion of the sinus may give rise to a sinus infection as well as a dental implant that is only loosely held by the deficient bone. The implant is therefore incapable of properly supporting a dental bridge.

To overcome this problem, Linkow in his above-identified patent as well as in his earlier U.S. Pat. No. 4,521,492 discloses a technique in which the bone to be implanted is augmented before the dental implant is installed therein.

In the Linkow technique, the Schneiderain membrane lining the sinus cavity is lifted to expose the floor of the sinus cavity on which is then deposited a charge of bone chips or particles. These particles act to thicken and augment the maxilla whereby new bone is developed about the particles to create a graft which is fused to the maxilla.

The osteo-integration grafting process in which the particles fuse with the maxilla is gradual and at a pace that cannot be accelerated. Hence it usually takes a time period lasting about six months before the maxilla is augmented and in condition to accommodate a dental implant. When thereafter a hole is drilled into the augmented maxilla and the threaded root section of the implant is screwed into this hole, it then takes an additional six-month period for the implant to fuse with the bone. It is only after the succeeding six-month period that it becomes feasible to mount a dental bridge on the post of the implant.

This two-stage procedure and the protracted time period entailed thereby during which the patient still has missing teeth has discouraged many patients from submitting to this procedure and to the expenses incurred thereby. A single stage dental implant procedure is not inexpensive. But the more time-consuming and more difficult two-stage procedure during which the maxilla is augmented is for many patients prohibitively expensive. Hence while these patients may benefit from a two-stage dental implant procedure, they are denied their benefits.

Of particular prior art interest is the sinus dental implant stabilizer assembly disclosed in the U.S. patent to Sendax. This assembly comprises an elongated implant having an internal recess at one end, an insert removably fitting into said recess, and having a head projecting laterally beyond said recess, a washer capable of being removably held in fixed position by said implant and insert, and a nut having an opening to fit over said implant of a size and internal configuration so as to be held in position on the implant, said nut holding said nut securely when said implant is being inserted into said nut.

The drawback of the Sendax assembly is that it is not resistant to external forces which seek to unscrew the implant from the hole in the bone in which it is screwed and in doing so to loosen the nut. It is only after the prolonged period during which the bone is fused to the metal implant that the implant cannot unscrew from the bone.

### SUMMARY OF THE INVENTION

In view of the foregoing, the main object of this invention is to provide a technique entailing a single stage procedure for installing a dental implant assembly in the maxilla of a patient suffering from bone loss, in which procedure the maxilla is augmented by a bone graft and the implant is anchored in the graft.

More particularly, an object of this invention is to provide a dental implant assembly for carrying out the above technique, the assembly being composed of a root section threaded to define a screw, a post section attachable to the rear end of the root section onto which a dental bridge is mountable, and a locking element section attachable to the nose at the front end of the root section which in the installed implant functions as a stabilizing anchor therefor. The looking element can either be a nut that screws onto the nose or a U-shaped block that is attachable to the nose.

Among the significant advantages of the invention are the following:

A. Because it involves a single stage procedure, it takes no more time to complete an installation of the dental implant in an augmented maxilla than it would take to complete an installation in an unaugmented maxilla.

B. The osteo-integration fusing process to create a graft on the maxilla takes place concurrently with the fusing process to integrate the root section with the maxilla, thereby markedly reducing the total time it takes to complete an installation.

C. When the installation is complete, the nut section of the assembly is then embedded in the maxilla graft and serves to securely anchor the implant.

D. The nut section acts to securely lock the implant to the bone so that it is then resistant to external forces which seek to unscrew the implant.

E. The single stage procedure produces a dental implant in an augmented maxilla which is more stable and stronger than one produced in a two-stage procedure.

F. The expenses incurred by the patient in a single stage procedure to produce a dental implant in an augmented maxilla are substantially below those incurred in a two-stage procedure for the same purpose.

Also an object of the invention is to provide a dental implant assembly composed of root, post and nut sections which can be mass-produced at a relatively low cost.

Briefly stated, these objects are obtained in a technique for installing in the maxilla of a patent a dental implant assembly having a root section, a post section and a nut or locking element section. The root section is threaded to define a self-tapping screw which at its rear end is attachable to the post section and at its front end to the nut section.

To carry out this technique, the root section is screwed into a hole bored in the maxilla, the nose at the front end of the section then projecting into an adjacent sinus cavity. The membrane lining the sinus cavity is lifted to admit the nut section which is then turned onto the nose to lock the root section to the maxilla. Then a charge of bone particles is deposited in the cavity to cover the nut section and the surrounding maxilla region. In a time period lasting several months, the bone particles gradually fuse with and graft onto the maxilla to augment its structure and to embed the nut section therein. Concurrently in the same period, the root section proceeds to fuse with the maxilla. This period represents the total time it takes to complete the dental implant installation, after which it is then feasible to mount a dental bridge on the post section.

### BRIEF DESCRIPTION OF THE DRAWINGS

For a better understanding of the invention as well as other objects and further features thereof, reference is made to the annexed drawings wherein:

FIG. 1 is a perspective view of one embodiment of a dental implant assembly in accordance with the invention installable in an augmented maxilla;

FIG. 2 shows the tool for holding or turning the locking nut section of the assembly;

FIG. 3 shows the first step in a single stage procedure for installing the assembly;

FIG. 4 shows the step in the procedure in which a charge of bone chips is deposited on the surface of the maxilla to be augmented;

FIG. 5 schematically shows the assembly installed in the augmented maxilla.

FIG. 6 is a perspective view of a second embodiment of a dental implant assembly in accordance with the invention;

FIG. 7 shows a third embodiment of the assembly in which the locking element is a block attachable to the nose of the root section of the assembly;

FIG. 8 shows the block attached to the nose, and

FIG. 9 shows the underside of the block.

### DETAILED DESCRIPTION OF THE INVENTION

### FIRST EMBODIMENT

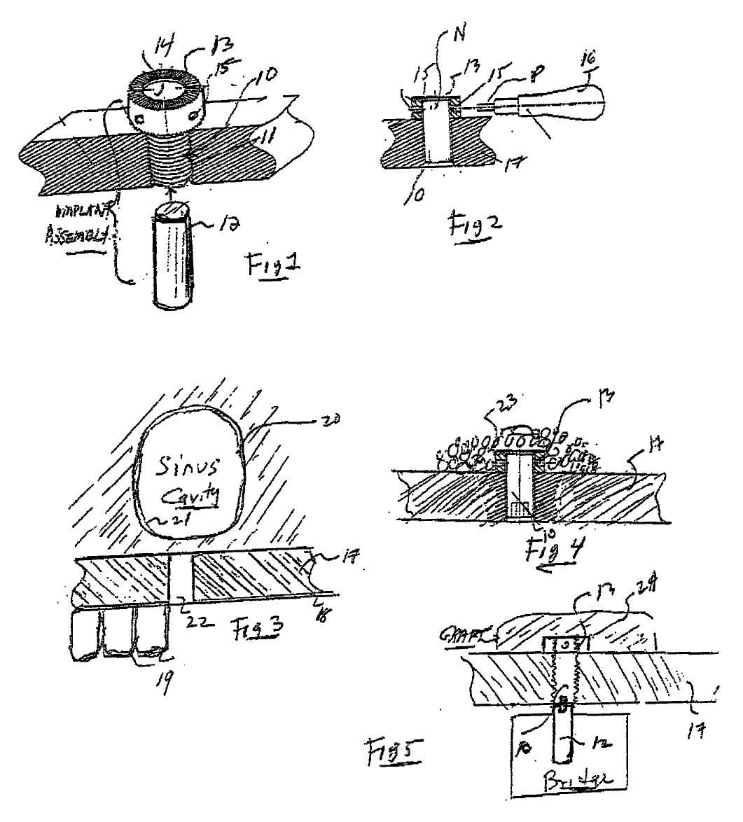

Referring now to FIG. 1 shown therein is a first embodiment of a dental implant assembly for installation in an augmented maxilla in accordance with the invention. The assembly is composed of the following three sections:

I. Root Section 10 formed by a cylindrical metal shank having an external threading 11 with a cutting edge defining a self-tapping screw which can be screwed into a hole bored in the maxilla.

II. Post Section 12 formed by an unthreaded metal rod which is attachable to the rear end of root section 10 and serves to support a dental bridge.

III. Nut Section 13 formed by a metal nut which screws onto a nose on the front end of root section 10 and is provided for this purpose with an internally threaded bore 14. This nut acts to lock the root section in place after being screwed into the bone hole.

Normally in order to hold or turn a nut on a threaded screw, one uses for this purpose a wrench whose head is adapted to socket the nut. But to engage the nut, the head of the wrench must first be raised above the nut and then brought down to engage it. In a technique in accordance with the invention, the tool used to hold or turn the nut must not be raised above the nut. To this end nut section 13 which is cylindrical is provided about its circumference with radial holes 15. Each hole acts as a socket to receive the prong P of a tool 16, as shown in FIG. 2. With the tool one can engage and hold the nut so that it can be turned onto nose N or the threaded nose can be turned into the nut. In FIG. 2, threaded root section 10 is shown screwed into a hole bored in maxilla 17, nose N then projecting from the maxilla.

All three sections of the assembly are fabricated of a chemically non-reactive and non-corrosive metal of high strength, capable of fusing with bone, preferably titanium or an alloy having similar characteristics. In practice, the nut section may be square, hexagonal or in any other nut configuration in which the nut can readily be held or turned by a tool.

Both the underside of nut 13 and its upperside are knurled or otherwise roughened. Hence when the nut is tightened against the surface of the maxilla the roughened underside which then frictionally engages this surface will resist turning out of the nut. And the roughened upperside promotes the fusion of a bone graft to the nut.

### Installation of Assembly

In order to install the dental implant assembly shown in FIG. 1 in the maxilla of a patient who has suffered a bone loss, it is necessary to augment the maxilla. As shown in FIG. 3, the maxilla 17 is provided with an alveolar ridge 18 from which project the teeth 19 of the patient. However, there are upper teeth missing, and the invention resides in a technique which augments the maxilla to render it implantable and installs the assembly in the augmented maxilla in a single stage procedure. Upon completion of this procedure, the dental implant assembly is then in a condition to support a bridge whose artificial teeth replace the missing teeth.

Above maxilla 17 is a sinus cavity 20 lined by a Schmeiderain membrane 21. Because of bone loss due to disease or aging, maxilla 17 is no longer capable of supporting a dental implant. It therefore becomes necessary to graft bone onto the maxilla to augment its structure so that it can effectively anchor a dental implant on which a dental bridge is to be mounted.

The first step in the installation procedure is to drill a hole 22 in maxilla 17 at the site at which the dental implant assembly is to be installed. The site is of course at the location in the upper jaw where teeth are missing.

The gauge of the drill bit used to bore hole 22 must match the shank diameter of root section 10 of the assembly so that when this section is screwed into the hole as shown in FIG. 4, it then taps the bank of this hole to incise an internal thread therein. Hence externally-threaded root section 10 can be turned into the internally-treaded hole to advance nose N at the front end of the section so that it projects beyond maxilla 16 into sinus cavity 19.

In order to admit nut section 13 into the sinus cavity so that it can be applied to the projecting nose of the dental insert section cavity membrane 21 is lifted to gain access to the nose in the sinus cavity. The nut is placed on the nose and turned thereon by tool 16 until it is tightened against the surface of the maxilla to mechanically lock the root section 10 to the maxilla. Alternatively, one may by means of tool 16 hold nut 13 while nose N is turned thereon until the nut is tightened against the bone surface.

Then a charge of bone chips or particles 23 is deposited under the lifted membrane in the sinus cavity to cover nut 13 and the maxilla region surrounding the nut. This point in the procedure represents an incipient phase of the installation, for the bone chips lie loosely on the surface of the unaugmented maxilla and root section 10 of the assembly, though mechanically locked to the maxilla, is not integrated therewith so that it is inseparable therefrom.

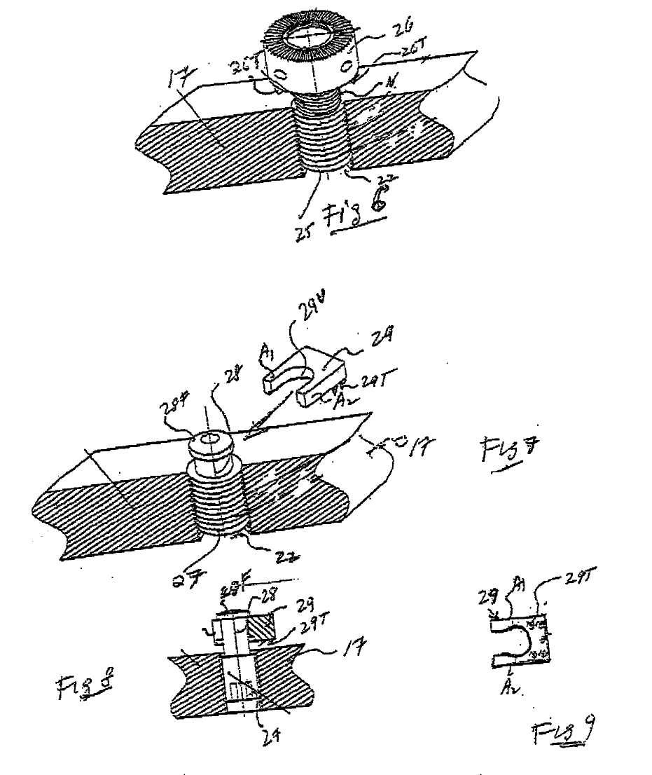

What then transpires over a time period lasting about six months are concurrent fusion processes. One osteo-integration process which takes place is the gradual growth of bone about the bone particles and their fusion with the maxilla to create a bone graft 24, as shown in FIG. 5. Nut 13 is then embedded in this graft.

The other process which runs concurrently with the grafting process during the same time period is a gradual fusion of the maxilla bone with the surface of root section 10 of the dental implant so that this section is then effectively rooted in the maxilla. Only when the installation of the dental implant assembly is fully set in an augmented maxilla is it then feasible to mount a dental bridge 23 on the post section 12 protruding from the maxilla.

The resultant installation is exceptionally stable and strong compared to a prior art two-stage installation in which a conventional dental implant is installed in an augmented maxilla. The reason for this significant difference is that nut section 13 embedded in bone graft 21G and joined to root section 10 which is integrated with maxilla 16 acts as an anchoring foundation very much in the manner in which the underground roots of a tree spread out to create a foundation anchoring the trunk of the tree.

As a consequence, a dental implant assembly in accordance with the invention is capable of withstanding strenuous external forces imposed on the dental bridge which seeks to dislodge the implant.

In some cases the maxilla of a patient is sufficiently strong to support a dental implant without the need to augment the maxilla.

Nevertheless an advantage is gained by installing in this strong maxilla an assembly in accordance with the invention in which the nut section acts to fasten to the maxilla the root section screwed into a hole drilled in the maxilla.

When a conventional dental implant is installed in a strong maxilla, one must wait about six months before mounting a dental bridge on the implant in order to permit the bone to fuse with the implant so that the implant cannot thereafter be caused by external forces to turn out of the threaded bone hole. But with an assembly in accordance with the invention in which the sinus membrane is lifted to permit a nut to be attached to the nose of the implant projecting into the sinus cavity, this nut, when tightened, acts to securely fasten the implant to the bone.

While after the implant is installed on the maxilla fusion of the bone to the implant will gradually take place inasmuch as the implant is then mechanically locked to the bone, there is no need to wait the usual six months for the fusion to be consummated before mounting a dental bridge on the implant.

Hence in those situations where it is unnecessary to augment a patient's maxilla, it is then possible after installing the dental implant assembly so that it becomes securely fastened to the bone, to the mount a dental bridge on the implant post without waiting for the fusion process to run its long course.

### SECOND EMBODIMENT

In this embodiment which is illustrated in FIG. 6, we have a self-tapping threaded root section 25 which functions as a screw that is screwed into a hole 22 drilled in maxilla 17. Projecting from the upper end of root section 25 into the sinus cavity is a threaded nose N which is engaged by a nut 26 having radial holes therein to receive the prong of tool 16 shown in FIG. 2.

The treading of root section 25 whose shank diameter matches the diameter of drilled hole 22 is right-handed (clockwise), whereas the threading of nose N whose diameter is somewhat smaller than that of the root section is left-handed (counter-clockwise). Also counterclockwise is the internal threading of nut 26 received on the nose.

The underside of nut 26 is provided with a set of sharp projections or teeth 26T capable of cutting into bone. The purpose of the differential threading is to facilitate the penetration of the teeth into the maxilla so that it becomes embedded therein to resist untightening of the nut despite external forces which seek to loosen the implant installation.

To install the assembly, nut 26 is inserted by the operator into the sinus cavity of the patient and then rotated counterclockwise on the nose projecting into the cavity whose threading is in the same direction. The nut is turned until its teeth 26T just touch the surface of the maxilla.

The operator then proceeds to turn the root section screwed into the hole bored in the maxilla in the counterclockwise direction in which the root section which had been screwed into the hole in the clockwise direction begins to turn out of the hole. This action causes the nut on the nose which is then held by the tool so that it cannot be turned, to be pulled down axially, thereby causing teeth 26T on the underside of the nut to eat into and become embedded in the bone.

It is important to bear in mind that the longevity of the dental implant depends on a tightened nut to lock the implant to the maxilla, which nut remains tightened regardless of external forces which seek to loosen the implant. Hence, one does not have to wait for the bone to fuse to the implant in order to prevent external forces from unscrewing the implant.

Root section 25 is provided with a bore that is internally threaded to receive a screw for attaching to the root section post for supporting a dental bridge. Root section 25 has a right-handed (clockwise) threading, whereas the threading of nose N and that of nut 26 threadably received on the nose for supporting a dental bridge is left handed. Also left-handed is the threading of the attachment screw and of the bore in root section 25. Hence, should the root section seek to turn out counter-clockwise, this action would cause further tightening of the nut and of the attachment of the post to the root section.

### THIRD EMBODIMENT

In this embodiment which is illustrated in FIGS. 7, 8 and 9, the root section 27 of the assembly which is screwed into hole 22 bored in maxilla 17 is the same as the root section 25 in FIG. 6. However nose 28 which projects from root section 28 into the sinus cavity is not threaded but is formed by a cylindrical boss whose diameter is somewhat smaller than that of the root section. On the head of the boss is a circular flange 28F of large diameter.

In this assembly, the fastening or locking element section is not a nut as in the other embodiments but a rectangular metal block 29 having a U-shaped recess 29U defining a pair of arms A1 and A2.

The underside of block 29 is provided with projecting pins or teeth 29T. This locking element is simple to install, for one has only to slide it onto boss 28, as shown in FIG. 8 so that arms A1 and A2 of the block straddle the boss and underlie flange 28F.

Then the operator us in the counterclockwise direction the root section 27 screwed into the hole drilled in maxilla 17. This action which seeks to unscrew the root section, causes the boss 28 projecting from the upper end of the root section to move downwardly and in doing so forces block 29 against the surface of the maxilla, the teeth 29T on the underside of the block then being punched into the bone. Hence once the locking block is pinned to the bone it cannot be displaced.

While there has been shown preferred embodiments of a dental implant assembly, it is to be understood that many changes and modifications may be made herein without departing from the spirit of the invention.

1. A dental implant assembly for installation in a hole bored in a maxilla of a patient suffering from loss of bone, said assembly comprising:
A. a root section formed by an externally-threaded shank to define a self-tapping screw having a nose projecting from the front end of the shank, which section when screwed into the hole then advances the nose to project from the maxilla into an adjacent sinus cavity;
B. a post section attachable to a rear end of the root section to support a dental bridge; and
C. a locking element section insertable into the sinus cavity adapted to be attached to the nose to fasten and securely lock the root section to the maxilla whereby the installation is resistant to external forces which seek to unscrew the root section.

2. An assembly as set forth in claim 1, in which the nose is threaded and the locking element is a nut threadably received on the nose.

3. An assembly as set forth in claim 2, in which said nut is provided at its underside with teeth which when the nut is tightened against the maxilla penetrate the maxilla and become embedded therein to resist untightening of the nut.

4. An assembly as set forth in claim 1, in which the nose is formed by a boss having a flange on its head, and said locking element is constituted by a horseshoe-shaped block that is slidable onto the boss, so that the arms of the horseshoe straddle the boss.

5. An assembly as set forth in claim 4, in which the block is provided with teeth which project from the underside of the block.

6. An assembly as in claim 1, in which the sections thereof are fabricated of a non-corrosive metal of high strength.

7. An assembly as set for in claim 6, in which the metal is titanium.

8. An assembly as set forth in claim 2, in which the nut section includes means engageable by a tool adapted to hold or turn the nut with respect to the root section.

9. An assembly as set forth in claim 8, in which said means are constituted by radial holes in the nut engageable by a tool having a prong.

10. A method for installing an implant assembly of the type set forth in claim 1 comprising the steps of:
A. drilling the hole in said maxilla;
B. screwing into the hole the threaded root section to advance the nose beyond the maxilla into the sinus cavity;
C. lifting a membrane lining the cavity to expose the nose; and
D. attaching the locking element section to the nose to lock the root section to the maxilla so that it is resistant to external forces which seek to unscrew the root section.

11. A method as in claim 10, further including the step of covering the locking element section in the cavity with a charge of bone particles to produce a bone graft.

12. A method as set forth in claim 9, further including the step of maintaining the charge of bone particles in the cavity for a time period sufficient to cause the particles to fuse to each other and to the maxilla to create a graft thereon in which the locking element section is embedded.

13. A technique for installing in the maxilla of a patient a dental implant assembly having a root section, a post section and a nut section, the root section being externally threaded to define a self-tapping screw which at its rear end is attachable to the post section and at its front end to the nut section, said technique comprising the steps of:
A. screwing the root section into a hole bored in the maxilla, whereby a threaded nose at the front end of the section then projects into an adjacent sinus cavity;
B. lifting a membrane lining the sinus cavity to admit the nut section therein which is then turned onto the nose to lock the root section to the maxilla so that it is resistant to external forces which seek to unscrew the root section; and
C. depositing a charge of bone particles in the cavity to cover the nut section and a surrounding maxilla region, whereby in a time period lasting several months, the bone particles gradually fuse with and graft onto the maxilla to augment its structure and embed the nut section therein, and concurrently in the same period, the root section proceeds to fuse with the maxilla to complete the installation.

14. A technique as set forth in claim 13, in which the period it takes for the graft to be formed is substantially coextensive in duration with the period it takes for the root section to fuse with the maxilla whereby the total time it takes for the installation to be fully set and in condition to accommodate a bridge depends on this duration.

15. A technique as set forth in claim 14, in which said, duration is approximately six months.

16. A technique as set forth in claim 13 in which a dental bridge is attached to the post section before fusion takes place.

17. An assembly as set forth in claim 2 in which the threading of the root section is right-handed and the threading of the nose and of the nut received thereon is left-handed whereby should the root section seek to turn out, it would cause further tightening of the nut.

18. An assembly as set forth in claim 16 in which the root section is provided with an internally threaded bore to threadably receive a screw for attaching to the root section a post for supporting a dental bridge, the threading of the bore and that of the screw both being left-handed whereby should the root section seek to turn out, it would cause further tightening of the post attachment.
